(19) United States
(12) Patent Application Publication
(10) Pub. No.: US 2006/0065987 A1
(43) Pub. Date: Mar. 30, 2006

(54) Two-stage injector-mixer

(76) Inventor: Justin Schletz, Yorba Linda, CA (US)

Correspondence Address: MARCIA A. DEVON;DEVON & ASSOCIATES, 400 OCEANGATE BLVD., SUITE 800, LONG BEACH, CA, 90802, US

(21) Appl. No.: 10/955,668

(22) Filed: Sep. 30, 2004

(51) Int. Cl. B01F 3/04

(52) U.S. Cl. 261/76; 261/79.2; 261/DIG. 75

(57) ABSTRACT

An injector-mixer for injecting and thoroughly mixing fine bubbles of air into a contaminated water stream from a fish tank is disclosed. Water is pumped down through an injection section of the present invention where air is injected into the stream by an improved Venturi construction. The mixture then flows into an improved mixing section, where it is thoroughly mixed such that the plethora of small air bubbles have a greater chance to bond with the contaminants of the water, the contaminants becoming buoyant as a result. Upon introduction of the mixture into the protein skimmer column, the bubbles of air and contaminants attached thereto rise to the top of the protein skimmer column to be contained, while the filtered and oxygenated water is returned to the tank.

### FIELD OF THE INVENTION

The present invention relates generally to devices for mixing a gas into a fluid stream, and more particularly, to a device adapted to mixing air into an aquarium water line in advance of a protein skimmer.

### DISCUSSION OF RELATED ART

Protein skimmers for fish aquariums have advanced considerably over the years and are now the favored means of filtering fish tank water. A protein skimmer serves to both introduce very small air bubbles into the aquarium water so as to oxygenate the water for the benefit of the fish, and also to mix air bubbles into the water for the containment of pollutants in the water. Pollutants bond to the air molecules and as a result, become buoyant and are then collected at a top area of the protein skimmer, while the filtered and oxygenated water is returned to the fish tank.

The efficiency of a protein skimmer may be measured by the volume of pollutants filtered from the water in a given period of time, divided by the power required by the water pump driving the protein skimmer. It is desirable to increase the efficiency of a protein skimmer so that a smaller water pump may be used to keep a fish aquarium clean, which not only saves on electricity costs of running the pump but also reduces the noise associated with running the fish tank.

The efficiency of a protein skimmer is increased as pollutants are exposed to a larger amount of air for a longer period of time. Therefore, the efficiency of a protein skimmer is increased: (1) when the air bubbles are smaller and more numerous, increasing the total surface area of the air with the surrounding water, and (2) when the mixture of air and water are mixed vigorously with increased turbulence, such that the pollutants have more opportunity for exposure and bonding with the air.

Protein skimmers of the prior art consist generally of “downdraft” and “Venturi” type protein skimmers. Prior art downdraft type protein skimmers tend to require significant water pressure to operate effectively, and do not result in significantly turbulent water flow. Moreover, such prior art devices require a tall “downdraft” tube that is not often practical in a home environment. However, downdraft type protein skimmers do produce a significant number of small air bubbles and work well in a tall downdraft tube, so they tend to be favored in environments to which their use is suited, such as in retail pet stores and other large tanks.

“Venturi” type prior art protein skimmers can be more easily hidden from view, behind or under the fish tank, and do not require a tall downdraft tube. However, such prior art devices tend to clog with pollutants at the air injection point into the water stream, and do not produce as many bubbles as the downdraft type protein skimmers. For example, U.S. Pat. No. 5,863,128 to Mazzei on Jan. 26, 1999, discloses a Venturi type air injector that may be used with a protein skimmer apparatus.

Another prior art device, disclosed in U.S. Pat. No. 6,156,209 to Kim on Dec. 5, 2000, aims to generate air bubbles with a high-pressure water injector into an auxiliary tank, and to increase the turbulence of the resulting mixture flow. However, such a device requires an auxiliary tank and takes up considerable space.

Therefore, there is a need for an inexpensive and effective means by which to inject a substantial amount of small air bubbles into a water stream causing the vigorous mixing of the air and water before introducing the air and water mixture into a standard protein skimmer tank. An efficient device is required for use with smaller water pumps, and would be of a small enough to conceal behind a fish tank in a home environment, for example. The present invention accomplishes these objectives.

### SUMMARY OF THE INVENTION

The present invention is an injector and mixer device for injecting small bubbles of air into a contaminated water stream, and thoroughly mixing the air and the contaminated water before introducing the mixture into a protein skimmer column of a standard protein skimmer used in the fish aquarium filter industry. The present invention includes an injection section and a mixing section. In general, a stream of pumped water flows down through the injection section of the present invention and into the mixing section, where it is thoroughly mixed with a great multitude of tiny bubbles of air that serve to bond with the pollutants in the water, the contaminants becoming buoyant as a result of their attachment to the air bubbles. Upon introduction of the mixture into the protein skimmer column, the bubbles of air and the attached pollutants rise to the top of the protein skimmer column and are contained, while the filtered and oxygenated water is returned to the tank.

The injection section serves to inject the air into the water stream. The injection section comprises a body with a first end and a second end and a flow passage formed through from the first end to the second end. The flow passage is defined by a circularly sectioned wall that extends along a central axis of the body from a liquid inlet port at the first end to a mixture outlet port at the second end. The wall defines several distinct portions along its central axis, namely, an entry portion, a nozzle portion, an injection portion, a funnel portion, an expansion portion, and an exit portion, the flow passage being formed through each said portion in turn from the inlet port to the exit port.

The contaminated water is pumped through the entry section and into the ever narrowing nozzle section, where the water stream velocity is increased as it passes into the injection portion, which includes an injection port interconnected to gas inlet port. The high velocity of the water exiting the nozzle section pulls air through the gas injection port by Venturi effect, whereupon the air is injected into the water stream as the water stream leaves the injection portion and enters the funnel portion. From the funnel portion the mixture of air and water enters the expanding portion and then the exit portion, where it leaves the injection section and enters the mixing section at a mixture inlet port thereof.

The mixing section comprises a generally cylindrical vortex chamber with an open end and a closed end. A mixing chamber extends through the cylindrical vortex chamber from the open end and terminates at the closed end. The mixing chamber is defined by a circularly section wall extending along a central axis of the cylindrical vortex chamber from the open end to the closed end. The mixture inlet port enters the mixing chamber through the wall immediately adjacent to the closed end and tangentially to the wall. As such the mixture swirls around the mixing chamber to promote greater exposure of the pollutants in the water with the air, before the mixture exits the mixing section at the open end and enters the protein skimmer column.

The entry portion and nozzle portion of the injection section may be readily formed by turning a thick-walled PVC pipe, or the like, on a lathe. In larger quantities, such an inlet pipe is easy to produce with injection molding. Further, and in a similar manner, an exit pipe may be formed that includes the funnel portion, the expanding portion, and the exit portion. Both such inlet and exit pipes may be joined with a standard T-shaped connector that holds the inlet and exit pipe in coaxial alignment, the injection portion being formed naturally by the gap between the inlet and exit pipes when so joined. The third opening of the T-shaped connector is then fitted with a gas inlet port to complete the injection assembly. As such, the injection assembly may be manufactured very inexpensively. Such an injection assembly does not suffer from contaminants plugging the air inlet port due to the size of the inlet port. Yet, at the same time, the mixture of water and air does not back-up into the air inlet port due to the shape of the funnel portion and the subsequent expanding portion. Mounting the injection section vertically with the flow of water downward further prevents water from backing-up into the air inlet port, as gravity further compels the water and air mixture down into the mixing section.

The present invention provides a means for effectively mixing fine bubbles of air into a water stream without the need for a relatively large water or air pump or a large downdraft column or the like. As a result, not only is the present invention inexpensive, but it is also fairly compact and can be easily kept out of view while in use. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a left-side elevational illustration of the invention, shown with an injection section and a mixing section thereof, the mixing section attached to a partial view of a protein skimmer; and

FIG. 2 is a cross-sectional view of the invention, taken generally along lines 2-2 of FIG. 1.

### DETAILED DESCRIPTION OF THE PREFERRED EMBODIMENT

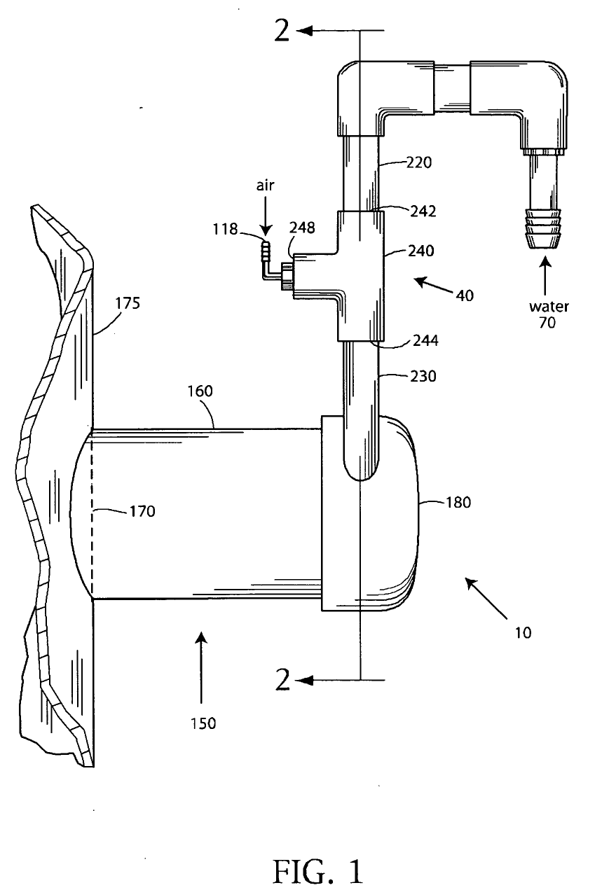

The present invention is an injector and mixer device for injecting a gas 20 into a liquid stream 30, and then thoroughly mixing the gas 20 and the liquid 30 before introducing the mixture thereof into a protein skimmer column 175. FIG. 1 illustrates the device, which comprises an injection section 40 and a mixing section 150, and shows a partial protein skimmer column 175 as is common in the fish aquarium filter industry. With the liquid 30 being a mixture of water and pollutants from a fish tank (not shown), and with the gas 20 preferably being ambient air at ambient pressure, stream of liquid 30 flows down through the injector-mixer of the present invention and to be thoroughly mixed with a great multitude of tiny bubbles of gas 20 that serve to bond with the pollutants of the liquid, the pollutants becoming buoyant as a result. Upon introduction of the liquid-air 20, 30 mixture into the protein skimmer column 175, the bubbles of gas 20 and pollutants attached thereto rise to the top of the protein skimmer column 175 to be contained, while the filtered and oxygenated water is returned to the tank.

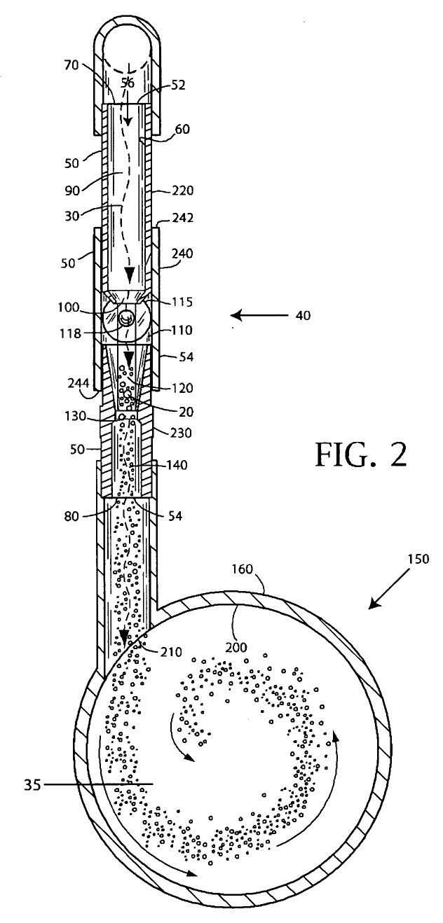

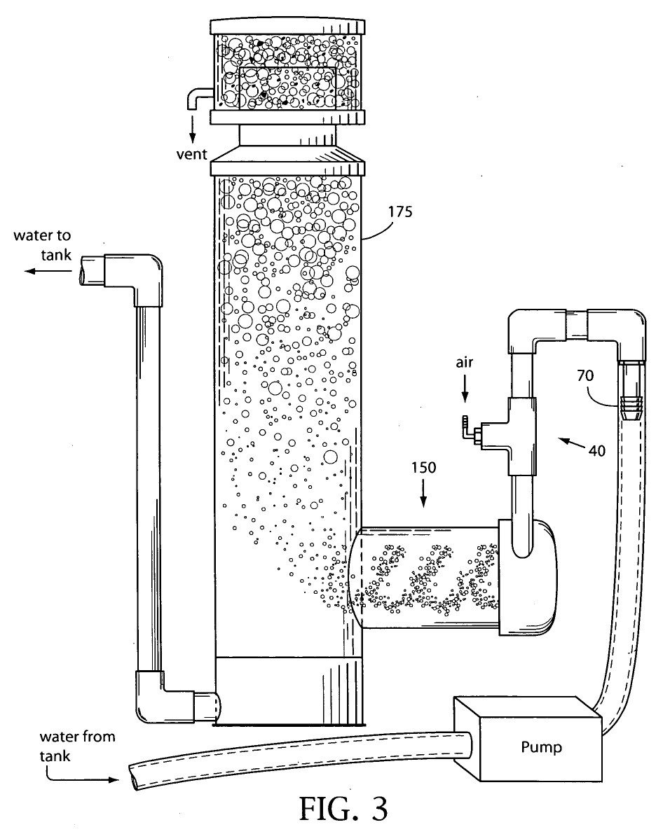

The injection section 40 serves to inject the gas 20 into the liquid stream 30. The injection section 40 comprises a body 50 with a first end 52 and a second end 54. A flow passage 56 is formed through the body 50 from the first end 52 to the second end 54 (FIG. 2). The flow passage 56 is defined by a circularly sectioned wall 60 that extends along a central axis of the body 50 from a liquid inlet port 70 at the first end 52 to a mixture outlet port 80 at the second end 54. Such a body 50 may be formed from PVC or ABS plastic, or the like.

The wall 60 defines several distinct portions along its central axis, from the first end 52 to the second end 54. The liquid inlet port 70 at the first end 52 of the body 50 is interconnected to a cylindrical entry portion 90. Liquid 30 from, for example, a fish tank pump (not shown) is introduced under pressure into the injection section 40 through the inlet port 70 at the first end 52. Such an inlet port 70 may be fluidly interconnected with a water pump hose (not shown) or the like through any suitable means known in the prior art, such as a hose fitting (FIG. 1). The liquid 30 travels through the cylindrical entry portion 90, which is interconnected to a frustoconical nozzle portion 100, where the cross-sectional diameter of the nozzle portion 100 reduces, preferably by at least forty percent, as the fluid 30 moves therethrough. As such, the velocity and pressure of the fluid 30 increases to a point where it exits the nozzle portion 100 at a significantly high speed and in a coherent stream. The nozzle portion 100 opens into a generally cylindrical injection portion 110, which includes an injection port 115 interconnected to a gas inlet port 118. Preferably the nozzle portion 100 extends at least partially into the projection of the injection port 115 into the injection portion 110. This is best illustrated in FIG. 2, where the nozzle portion 100 is shown slightly overlapping the injection port 115 in cross-section.

The high velocity of the liquid 30 exiting the nozzle section 100 pulls the gas 20 through the gas injection port 115 in a Venturi effect, whereupon the gas 20 is injected into the liquid stream 30 as the liquid stream 30 leaves the injection portion 110 and enters a frustoconical funnel portion 120, itself being interconnected to the injection portion 110.

The liquid 30 and gas 20 form a mixture 35 that is directed by the narrowing wall 60 in the funnel portion 120 into a relatively short frustoconical expanding portion 130, which is interconnected to a cylindrical exit portion 140 having a cross-sectional diameter preferably about twice that of the funnel portion 120 at the expanding portion 130. As such, the pressure and velocity of the liquid-gas mixture 35 is reduced. However, preferably the cross-sectional diameter of the entry portion 90 is at least fifteen percent greater than that of the exit portion 140, so that the velocity of the mixture 35 is great enough to promote more thorough mixing in the subsequent mixing portion 150. The liquid-gas mixture 35 exits the exit portion 140 at the mixture outlet port 80 at the second end 54 of the injection section 40, and enters the mixing section 150 at a mixture inlet port 210 thereof, the mixture inlet port 210 being interconnected to the mixture outlet port 80 of the injection section 40.

In the preferred embodiment of the invention, the cross-sectional diameter of the nozzle portion 100 at the injection portion 110 is at least half of the cross-sectional diameter of the injection portion 110. Further, the cross-sectional diameter of the gas injection port 115 is generally the same as that of the injection portion 110. As such, ample gas 20 flow completely around the stream of liquid 30 as the stream of liquid 30 exits the nozzle section 90 is possible, providing greater efficiency in injecting the gas 20 into the liquid stream 30.

Also in the preferred embodiment of the invention, the funnel section 120 is preferably at least fifty percent longer than the cross-sectional diameter of the funnel section 120 at the injection section 110. As such, the wall 60 at the funnel section 120 forms only a slight angle with respect to the central axis of the funnel section 120, providing a greater distance in which to allow the injection of the gas 20 into the liquid 30. Such an elongated funnel section 120 further provides less chance for any liquid 30 that becomes separated from the stream of liquid 30 to be deflected anywhere but into the subsequent expanding portion 130. The cross-sectional diameter of the funnel portion 120 at the expanding portion 130 is preferably the same as or only slightly larger than the cross-sectional diameter of the nozzle portion 100 at the injection portion 110, as same needs to accommodate the mixture 35 of liquid 30 and the more compressible gas 20, while still forcing the gas 20 to be finely injected into the liquid 30.

The mixing section 150 comprises a generally cylindrical vortex chamber 160 with an open end 170 and a closed end 180. The vortex chamber 160 is defined by a cylindrical section wall 200 extending along a central axis of the vortex chamber 160 from the open end 170 to the closed end 180. The mixture inlet port 210 enters the mixing chamber 190 through the wall 200 immediately adjacent to the closed end 180 and tangentially to the wall 200 (FIG. 2). As such the mixture 35 swirls around the vortex chamber chamber 160 in a turbulent eddy to promote greater exposure of the pollutants in the liquid 30 with the gas 20. The mixing section 150 is preferably formed from a PVC pipe, or the like, that is several times larger in diameter than the body 50. The closed end 180 may be a standard PVC cap used in the plumbing industry, designed to fit around one end of the mixing section 150.

In the preferred mode of the invention, the entry portion 90 and the nozzle portion 100 are integrally formed as an inlet pipe 220. Further, the funnel portion 120, the expansion portion 130, and the exit portion 140 are integrally formed as an exit pipe 230. As such, a T-shaped connector 240 may be used as the injection portion 110, the T-shaped connector 240 having a first open end 242 coaxially aligned with a second open end 242, and a third circular open end 248 with an axis that is transverse to the axis of the first and second open ends 242, 244. With the nozzle portion 100 side of the inlet pipe 220 inserted into the first open end 242, and the funnel portion 120 of the exit pipe 230 inserted into the second open end 244, the injection portion 110 is formed in between the inlet pipe 220 and the exit pipe 230 within the T-shaped connector 240. The gas inlet port 118 may then be inserted into the third circular open end 248 of the T-shaped connector to complete the injection section 40. Further, mounting the injection section 40 vertically with the flow of liquid 30 downward prevents the liquid 40 from backing-up into the gas inlet port 115, as gravity further compels the mixture 35 down into the mixing section 150.

Cleary, the body 50 of the injection section 40 may be made from one integral part, preferably from injection molded PVC or ABS plastic or the like. However, a mold to make such a one-piece injection section 40 is extremely complicated and expensive, and as such fairly impractical. It is much less expensive to manufacture a mold to make the inlet pipe 220 and, separately, the exit pipe 230 each as integral parts, and as such a T-shaped connector 240 that is commonly used in outdoor sprinkler applications may be used to hold the inlet pipe 220 and the exit pipe 230 in mutual co-axial alignment while forming therein the injection portion 110. Alternatively, the inlet pipe 220 and the exit pipe 230 may each be formed by turning on a lathe, although this is most well-suited for the manufacture of only small quantities of the invention. The inlet pipe 220, the exit pipe 230, and the gas inlet port 118 may all be fixed within the T-shaped connector 240 with conventional PVC pipe adhesive or the like.

While a particular form of the invention has been illustrated and described, it will be apparent that various modifications can be made without departing from the spirit and scope of the invention. For example, the exact relatively lengths of the various sections 90, 100, 110, 120, 130 and 140 may be slightly modified, or the materials used may be substituted with similarly rigid materials such as acrylic or the like. Accordingly, it is not intended that the invention be limited, except as by the appended claims.

1. An injector-mixer for injecting a gas into a liquid stream and for mixing the gas with the liquid in a column of liquid, the injector-mixer comprising:
an injection section including an injection port comprising a body with a first and
a second end, and a flow passage therethrough from the first to the second end;
a liquid inlet port at said first end of said injector section;
a mixture outlet port at said second end;
a nozzle interconnected to said injector section;
gas inlet port connected to said injection section;
a funnel interconnected to the injection portion; and
an expanding portion interconnected to said injection section and
wherein said expanding portion is connected to said funnel permitting flow between said injector section and the column of liquid.

2. The injector-mixer of claim 1 further including a mixing section comprising a vortex chamber with an open end and a closed end, a mixing chamber therethrough extending from the open end and terminating at the closed second end, the mixing chamber being defined by a circularly sectioned wall extending along a central axis of said vortex chamber from the open end to the closed end, the mixing section including a mixture inlet port entering the mixing chamber through the wall immediately adjacent to the closed end, a central axis of the mixture inlet port being tangential to the circularly sectioned wall, the mixture inlet port of the mixing section being interconnected with the mixture outlet port of the injection section.

3. The injector-mixer of claim 1 wherein the cross-sectional diameter of the nozzle portion at the entry portion is at least twice the cross-sectional diameter of the nozzle portion at the injection portion.

4. The injector-mixer of claim 1 wherein the cross-sectional diameter of the nozzle portion at the injection portion is at least half of the cross-sectional diameter of the injection portion.

5. The injector-mixer of claim 1 wherein the injection port of the injection portion is defined by a circularly sectioned wall extending along a central axis thereof, the central axis of the injection port being perpendicular to the central axis of the body of the injection section, the cross-sectional diameter of the injection port being generally equal to the cross-sectional diameter of the injection portion.

6. The injector-mixer of claim 1 wherein the funnel section is at least fifty percent longer than the cross-sectional diameter of the nozzle section at the injection section.

7. The injector-mixer of claim 2 wherein the cross-sectional diameter of the nozzle portion at the injection portion is generally the same size as the cross-sectional diameter of funnel at the expanding portion.

8. The injector-mixer of claim 1 wherein the cross-sectional diameter of the entry portion is at least fifteen percent greater than the cross-sectional diameter of the exit portion.

9. The injector-mixer of claim 4 wherein the nozzle portion extends at least partially across the projection of the injection port into the injection portion.

10. The injector-mixer of claim 1 wherein the entry portion and the nozzle portion are integrally formed as an inlet pipe; the funnel portion, expansion portion, and exit portion being integrally formed as an exit pipe; and the injection portion being formed from a T-shaped connector for receiving at a first circular open end the inlet pipe and for receiving at a second circular open end that is coaxially aligned with the first circular open end the exit pipe, the third circular open end being perpendicularly aligned with the axis of the first and second circular open ends for receiving the gas inlet port.

11. The injector-mixer of claim 5 wherein the nozzle portion extends at least partially across the projection of the injection port into the injection portion.
